(19) United States
(12) Patent Application Publication
(10) Pub. No.: US 2010/0299875 A1
(43) Pub. Date: Dec. 2, 2010

(54) HINGE

(75) Inventor: WEN-BIN SHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/499,097

(22) Filed: Jul. 8, 2009

(30) Foreign Application Priority Data
May 27, 2009 (CN) 200920303703.6

(51) Int. Cl. E05D 11/10; E05F 1/08

(52) U.S. Cl. 16/297; 16/319

(57) ABSTRACT

A hinge includes a rack, a shaft, a bracket, a number of elements, and a fastener. The shaft includes a rectangular-shaped post and a rectangular-shaped engaging portion secured to the rack. The bracket defines a pivot hole for rotatably receiving the post of the shaft. The number of elements is unrotatably arranged around the rectangular-shaped post of the shaft. The fastener is screwed on a distal end of the post to limit the bracket and the number of elements on the shaft.

### BACKGROUND

1. Technical Field

The disclosure relates to a hinge.

2. Description of Related Art

A collapsible device, such as a notebook computer, or a clamshell mobile phone, generally including a main body and a cover often uses a hinge to interconnect the main body and the cover. The hinge allows the cover to be rotatable with respect to the main body, and to be folded with the main body for saving space.

A hinge normally includes a shaft fixed to the main body of the collapsible device, and a bracket fixed to the cover of the collapsible device. The shaft is rotatable with respect to the bracket when the cover of the collapsible device rotates relative to the main body of the collapsible device. A plurality of elements, such as interfering members, friction washers, stop washers, and so on, are arranged around the shaft for providing added functions. The plurality of elements is fixed or rotatable to the shaft. However, the shaft needs time-consuming processing, in order to have a double-D shaped cross section, for unrotatably fixing some elements to the shaft. The manufacturing method for the shaft usually includes: forging a pole to a cylinder; cutting the cylinder to form two planes opposite to each other; and threading a distal end of the cylinder, which is laborious.

### BRIEF DESCRIPTION OF THE DRAWINGS

FIGS. 1 and 2 are exploded, isometric views of an exemplary embodiment of a hinge, but viewed from different perspectives.

FIG. 3 is an assembled, isometric view of the hinge of FIG. 1.

### DETAILED DESCRIPTION

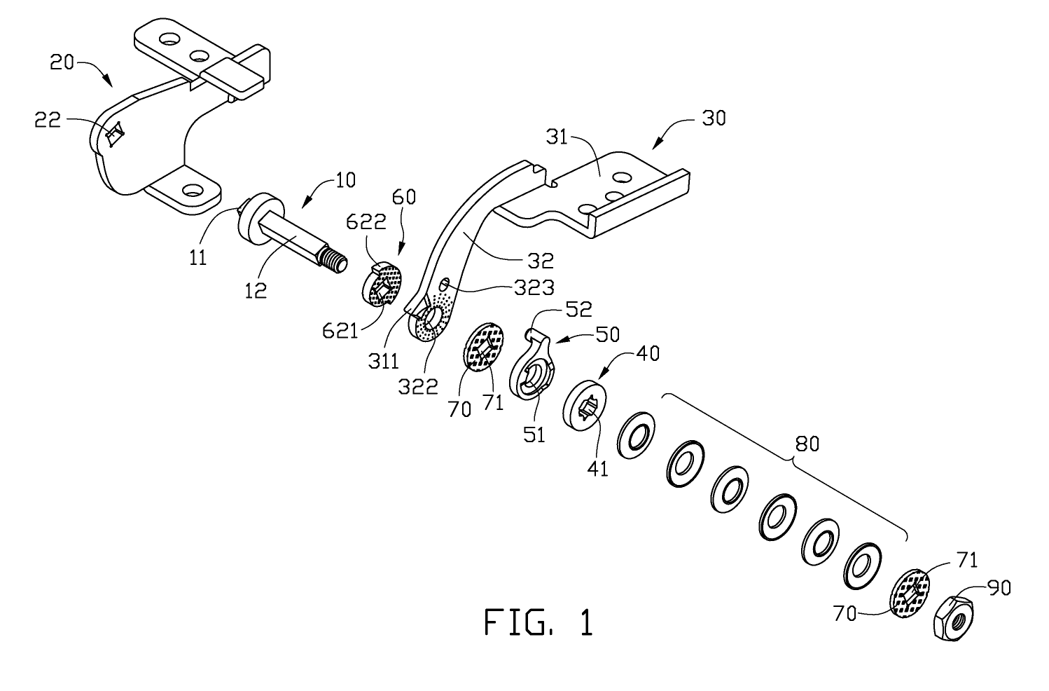

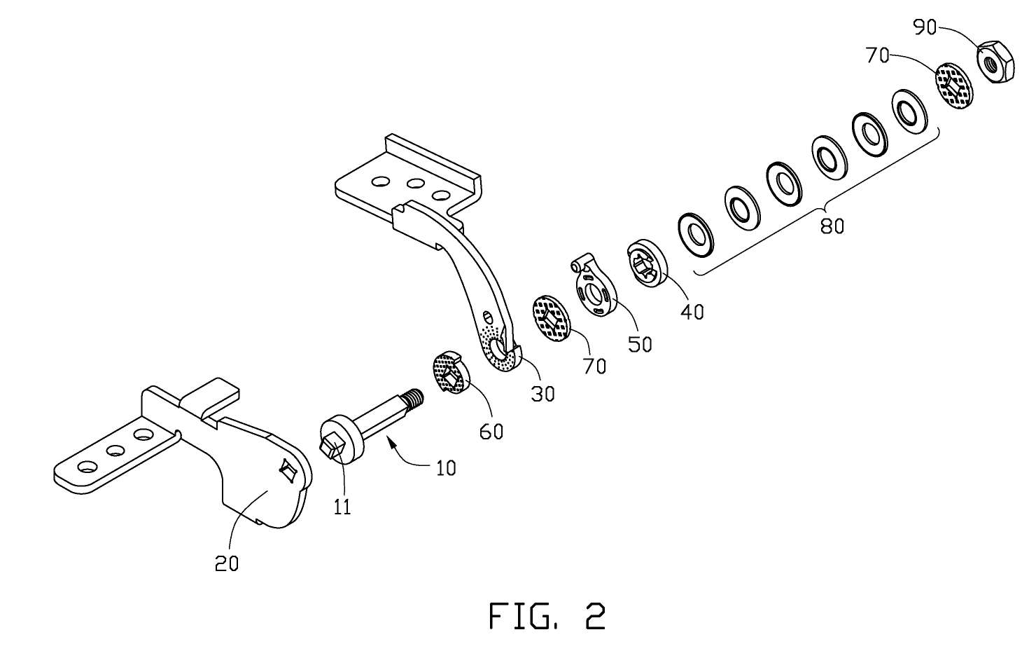

Referring to FIGS. 1 and 2, an exemplary embodiment of a hinge is adapted to be mounted to a collapsible device, such as a notebook or a clamshell mobile phone, that includes two parts rotatably connected to each other via the hinge. The hinge includes a shaft 10, a rack 20, a bracket 30, a plurality of first elements non-rotatably fixed to the shaft 10, a plurality of second elements rotatably arranged around the shaft 10, and a fastener 90. In this embodiment, the plurality of first elements includes a first interfering member 40, a limiting member 60, and two washers 70. The plurality of second elements includes a second interfering member 50 and a resilient assembly 80.

The shaft 10 includes a generally cylindrical-shaped flange (not labeled), with a post 12 and an engaging portion 11 protruding from opposite sides of the flange. The post 12 has a rectangular-shaped cross section. A distal end away from the flange of the shaft 10 forms a threaded portion. The engaging portion 11 has a rectangular-shaped cross section to fix the shaft 10 to the rack 20.

The rack 20 is provided to be mounted to one part of the collapsible device (not shown in pictures). The rack 20 defines a rectangular-shaped engaging hole 22 corresponding to the engaging portion 11.

The bracket 30 includes a main body 31 and an arm 32 extending from a side of the main body 31. The main body 31 defines a plurality of securing holes (not labeled), for mounting the bracket 30 to the other part of the collapsible device (not shown in pictures). The arm 32 defines a round pivot hole 322, for rotatably receiving the post 12 of the shaft 10. The arm 32 also defines a positioning hole 323 adjacent to the pivot hole 322. A restricting block 311 extends from a side of the arm 32 towards one surface of the flange 32. A plurality of receiving holes (not labeled) is defined in the flange 32, around the pivot hole 322 for retaining lubricant.

The first interfering member 40 defines a generally rectangular-shaped through hole 41, corresponding to the cross section of the post 12 of the shaft 10, to snugly fit about the post 12. A side of the first interfering member 40 facing the second interfering member 50 forms a first engaging portion (not labeled), such as a recessed portion in the illustrated embodiment.

The second interfering member 50 defines a round through hole 51, for rotatably receiving the post 12. A side of the second interfering member 50 facing the first interfering member 40 forms a second engaging portion (not labeled), such as a raised portion in the illustrated embodiment, to engage with the first engaging portion of the first interfering member 40. An inserting portion 52 is formed on a circumference of the second interfering member 50, for inserting into the positioning hole 323 of the bracket 30, to fix the second interfering member 50 to the bracket 30.

The limiting member 60 is generally washer-shaped, and defines a rectangular-shaped shaft hole 621 in a center of the limiting member 60, corresponding to the cross section of the post 12 of the shaft 10, for unrotatably fitting about the post 12 of the shaft 10. The limiting member 60 defines an arc-shaped cutout (not labeled) along a circumference of the limiting member 60. The limiting member 60 forms a stop portion 622 opposite to the arc-shaped cutout.

Each of the washers 70 defines a quadrate-shaped through hole 71 in a center of the washer 70, to snugly fit about the post 12. Opposite sides of the washer 70 define a plurality of receiving holes, for retaining lubricant.

The resilient assembly 80 includes a plurality of resilient frictional washers. These washers are stacked together, and rotationally retained around the post 12. In an alternative embodiment, the resilient assembly 80 can be a spring or other resilient component. The fastener 90 is a hexagonal nut, and can be screwed to the threaded portion of the post 12.

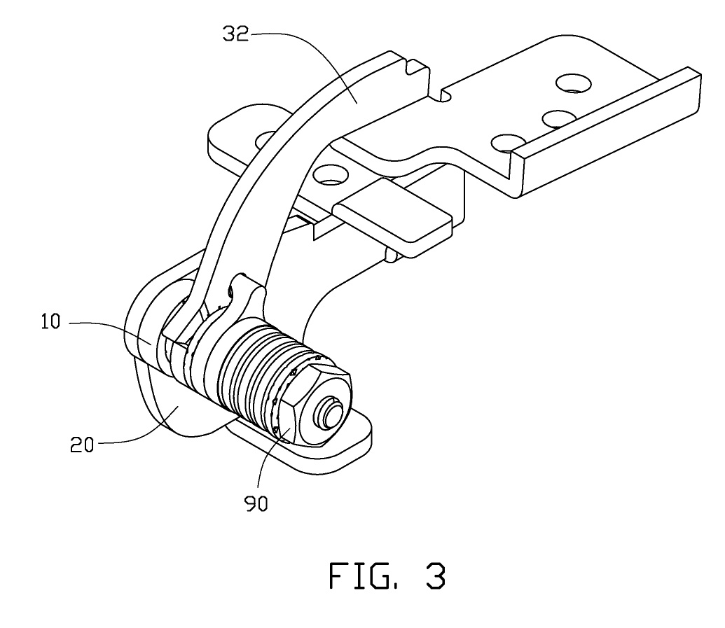

Referring to FIG. 3, in assembly, the engaging portion 11 of the shaft 10 is inserted into the engaging hole 22 of the rack 20. The post 12 of the shaft 10 is inserted through the shaft hole 621 of the limiting member 60, the pivot hole 322 of the bracket 30, the through hole 71 of one of the washers 70, the through hole 51 of the second interfering member 50, the through hole 41 of the first interfering member 40, the resilient assembly 80, and the through hole 71 of the other washer 70, in that order, to be screwed to the fastener 90. The inserting portion 52 of the second interfering member 50 is inserted into the positioning hole 323 of the bracket 30. The second engaging portion of the second interfering member 50 is engagable with the first engaging portion of the first interfering member 40.

In use, the shaft 10 rotates in the pivot hole 322 of the bracket 30. After the shaft 10 rotates an angle, the restricting block 311 of the bracket 30 resists against the stop portion 622 of the limiting member 60 to prevent the shaft 10 from rotating further.

A manufacturing method of the shaft 10 includes the follow steps: forging a pole to a rectangular-shaped shaft; and threading a distal end of the quadrate shaped shaft. The process is labor-saving.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a rack;
a shaft comprising a rectangular-shaped post, and a rectangular-shaped engaging portion secured to the rack;
a bracket defining a pivot hole for rotatably receiving the post of the shaft;
a plurality of first elements unrotatably arranged around the post of the shaft; and
a fastener screwed to a distal end of the post to limit the bracket and the plurality of first elements on the shaft.

2. The hinge of claim 1, wherein the plurality of first elements comprise a first interfering member, a limiting member, and two washers.

3. The hinge of claim 2, further comprising a plurality of second elements rotatably arranged around the post of the shaft, wherein the plurality of second elements comprises a second interfering member contacting the first interfering member, and a resilient assembly.

4. The hinge of claim 3, wherein the first interfering member member is engagable with the second interfering member, the first interfering member is retained around the post, and defines a quadrate through hole snugly fitting about the post to allow the first interfering member rotate with the post, the second interfering member is mounted to the bracket, the post is rotatably inserted through the second interfering member.

5. The hinge of claim 3, wherein the resilient assembly is rotatably retained around the post, the fastener is fixed to the distal end of the post to limit the second interfering member, the first interfering member, the limiting member, the bracket and the resilient assembly on the post, and the resilient assembly is located between the first interfering member and the fastener.

6. The hinge of claim 5, wherein the resilient assembly comprises a plurality of resilient washers, these washers are stacked together and rotationally retained around the post.

7. The hinge of claim 3, wherein the bracket defines a positioning hole, the second interfering member forms an inserting portion inserted into the positioning hole, to fix the second interfering member to the bracket.

8. The hinge of claim 2, wherein the bracket comprises a main body and an arm portion extending from a side of the main body, the pivot hole is defined in the arm portion, for rotatably receiving the post of the shaft, a restricting block is formed along a side of the arm portion.

9. The hinge of claim 8, wherein the limiting member forms a stop portion, for resisting against the restricting block of the bracket.

10. The hinge of claim 8, wherein the limiting member is generally washer-shaped, and defines a rectangular-shaped shaft hole in a center of the limiting member, for unrotatably fitting about the post of the shaft.

11. The hinge of claim 9, wherein the stop portion is formed along a circumference of the limiting member.
